(19) United States
(12) Patent Application Publication
(10) Pub. No.: US 2020/0133461 A1
(43) Pub. Date: Apr. 30, 2020

(54) SYSTEM AND METHOD FOR NAVIGATION OF A VIRTUAL ENVIRONMENT ON A HANDHELD DEVICE

(71) Applicant: Brittany Rene Brousseau, San Francisco, CA (US)

(72) Inventor: Brittany Rene Brousseau, San Francisco, CA (US)

(21) Appl. No.: 16/664,848

(22) Filed: Oct. 26, 2019

Related U.S. Application Data
(60) Provisional application No. 62/751,553, filed on Oct. 27, 2018.

(51) Int. Cl. G06F 3/0481; G06F 3/0488; G06T 19/00; G06F 3/0482; G06F 3/01

(52) U.S. Cl. CPC G06F 3/04815; G06F 3/04883; G06F 3/017; G06F 3/0482; G06F 3/011; G06T 19/003

(57) ABSTRACT

Systems and methods for navigation within a virtual environment using a mobile device is disclosed. In the embodiments of the invention, one or more novel User Interfaces are used to allow a user navigate within a virtual environment simulated on the touch screen of a mobile device, to explore the virtual environment using navigational elements instead of having to physically move about the virtual environment.

### CROSS REFERENCE TO RELATED APPLICATION

This application claims priority from the provisional application No. 62/751,553, entitled “System and Method for Navigation of a Virtual Environment on a Handheld Device,” filed on Oct. 27, 2018, the entirety of which is incorporated herein by reference for all purposes.

### SUMMARY

One embodiment of the present invention provides a system and user interface for navigation of a virtual environment on handheld mobile devices. A mobile device may be used, for example, to view a virtual environment such as an augmented reality portal. The mobile device, when used to view an immersive virtual environment is like a window to another world where as you move the mobile device around, you will see different view of the other world depicted by the virtual environment. In other words, just as virtual reality headsets allow a user to be immersed in a virtual environment, the same virtual environment can be simulated on a mobile device and the user can use the mobile device to look around a virtual environment.

Previously users had to navigate such an environment by physically moving their mobile device in various directions and orientation to view different areas of a virtual environment. Furthermore, users had to walk within the virtual environment to access various locations within the virtual environment. However, there are cases where navigation within a virtual environment is difficult because the size of the virtual environment is larger than the dimension of the real environment in which the user is located. Furthermore, in some cases users may want to navigate a virtual environment without much maneuvering of their handheld device and/or walking around a virtual object. Embodiments of the present invention provide a novel user interface on mobile devices for navigation within virtual environments.

The novel user interface called the “free will” interface allows users to fully navigate a virtual environment without the need to physically move in the virtual environment or move around virtual objects. The user interface includes various buttons, wheels, and sliders that individually or in concert allow the user to efficiently move in all directions and view virtual objects from any angle.

### BRIEF DESCRIPTION OF THE FIGURES

FIG. 1 illustrates a schematic of an exemplary digital touch screen device, according to one embodiment.

FIG. 2A shows elements of an exemplary navigational user interface, according to one embodiment.

FIG. 2B shows direction of navigation according to one embodiment.

FIG. 2C shows direction of navigation according to one embodiment.

FIG. 3 shows elements of an exemplary navigational user interface, according to one embodiment.

FIG. 4 shows elements of an exemplary navigational user interface, according to one embodiment.

FIG. 5 shows elements of an exemplary navigational user interface, according to one embodiment.

FIG. 6 shows elements of an exemplary navigational user interface, according to one embodiment.

FIG. 7 shows elements of an exemplary navigational user interface, according to one embodiment.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

Embodiments of the invention provide a system and method to navigate a virtual environment on handheld devices. In some embodiments the navigational User Interface (UI) may also be used on desktop to navigate a virtual environment. Before describing the operation of the navigational UI, an example of a touch screen device that can be used to show the navigational UI is described below.

An overview of a typical touch screen is provided below. It will be understood by those skilled in the art, that the following overview will not be limiting and the description below explains the basic method of operation of touch screen devices. Electronic devices can use different methods to detect a person's input on a touch screen. Most of them use sensors and circuitry to monitor changes in a particular state. Many, including the iPhone (designed and manufactured by Apple, Inc. in California), monitor changes in electrical current. Others monitor changes in the reflection of waves. These can be sound waves or beams of near-infrared light. Other systems may use transducers to measure changes in vibration caused when finger hits the screen's surface or cameras to monitor changes in light and shadow.

When a finger is placed on the screen, it may change the state that the device is monitoring. In screens that rely on sound or light waves, a finger physically blocks or reflects some of the waves. Capacitive touch screens such as iPhone use a layer of capacitive material to hold an electrical charge. Touching the screen changes the amount of charge at a specific point of contact. In resistive screens, the pressure from a finger causes conductive and resistive layers of circuitry to touch each other, changing the circuits' resistance. In either case the detected touch by the hardware may then be translated into data by one or more firmware and such data be made available to the operating system which in turn allows software to receive such data and use it as needed.

In some embodiments, heuristics are used to translate imprecise finger gestures into actions desired by the user. The heuristics may be controlled by the software or may be controlled by lower level software within the operating system. For example, in iPhone, software (or Apps) receive the touch data from a class called UIResponder. The hardware generates electronic data that result from the finger touching the screen and provide that data to the operating system (iOS in case of iPhone). The operating system then provides that data to higher level software via one or more defined classes.

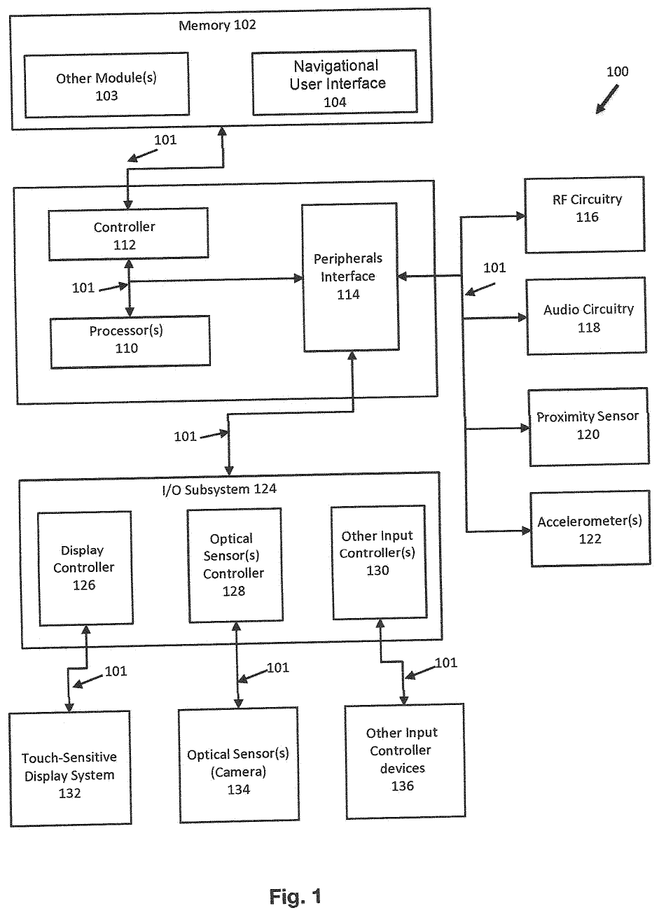

Attention is now directed towards embodiments of the device. FIG. 1 is a block diagrams illustrating portable multifunction computing devices 100 with touch-sensitive display 132 in accordance with some embodiments. The touch-sensitive display 132 is sometimes called a “touch screen” for convenience, and may also be known as or called a touch-sensitive display system. The device 100 may include a memory 102 (which may include one or more computer readable storage mediums), a memory controller 112, one or more processing units (CPU's) 110, a peripherals interface 114, RF circuitry 116, audio circuitry 118 (which include a speaker and a microphone), Proximity sensor 120, Accelerometer(s) 122, an input/output (I/O) subsystem 124, other input or control devices 130, Optical sensor(s) controller 128, display controller 126, touch sensitive display system 132, optical sensor(s) (camera) 134 and other input control devices 136. These components may communicate over one or more communication buses or signal lines 101.

It should be appreciated that the device 100 is only one example of a portable multifunction device 100, and that the device 100 may have more or fewer components than shown, may combine two or more components, or a may have a different configuration or arrangement of the components. The various components shown in FIG. 1 may be implemented in hardware, software or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-slate memory devices. Access to memory 102 by other components of the device 100, such as the processor(s) 110 and the peripherals interface 114, may be controlled by the memory controller 112.

The peripherals interface 114 couples the input and output peripherals of the device to the processor(s) 110 and memory 102. The processors(s) 110 run or execute various software programs and/or sets of instructions stored in memory 102 to perform various functions for the device 100 and to process data.

The I/O subsystem 124 couples input/output peripherals on the device 100, such as the touch screen 132 and other input/control devices 136, to the peripherals interface 114. The I/O subsystem 126 may include a display controller 126 and one or more input controllers 130 for other input or control devices. The input controllers 160 may receive/send electrical signals from/to other input or control devices 116. The other input/control devices 130 may include physical buttons (e.g., push buttons, rocker buttons, etc.), dials, slider switches, joysticks, click wheels, and so forth. In some alternate embodiments, input controller(s) 130 may be coupled to any (or none) of the following: a keyboard, infrared port, USB port, and a pointer device such as a mouse.

The touch-sensitive touch screen 132 provides an input interface and an output interface between the device and a user. As explained above, the display controller 126 receives and/or sends electrical signals from/to the touch screen 132. The touch screen 132 displays visual output to the user. The visual output may include graphics, text, icons, video, and any combination thereof (collectively termed “graphics”, “electronic content”, and/or “electronic data”). In some embodiments, some or all of the visual output may correspond to user-interface objects, further details of which are described below.

A touch screen 132 has a touch-sensitive surface, sensor or set of sensors that accept input from the user based on haptic and/or tactile contact. The touch screen 132 and the display controller 126 (along with any associated modules and/or sets of instructions in memory 102) detect contact (and any movement or breaking of the contact) on the touch screen 132 and convert the detected contact into interaction with user-interface objects (e.g., one or more soft keys, icons, web pages or images) that are displayed on the touch screen. In an exemplary embodiment, a point of contact between a touch screen 132 and the user corresponds to a finger of the user.

The touch screen 132 may use LCD (liquid crystal display) technology, or LPD (light emitting polymer display) technology, although other display technologies may be used in other embodiments. The touch screen 132 and the display controller 126 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 132.

A touch-sensitive display in some embodiments of the touch screen 132 may be analogous to the multi-touch sensitive tablets described in the following U.S. patents: U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety.

A touch-sensitive display in some embodiments of the touch screen 132 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

The touch screen 132 may have a resolution in excess of 100 dpi. In an exemplary embodiment, the touch screen may have a resolution of approximately between 326-401 dpi or more. The user may make contact with the touch screen 132 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user using various heuristics.

In some embodiments, the software components stored in memory 102 may include a navigational UI 104 which allows depicts various shapes on the touch-sensitive display 132 for navigation within a virtual environment. Memory 102 may include other modules that store various other control logics such as an operating system, a communication module (or set of instructions), a contact/motion module (or set of instructions), a graphics module (or set of instructions), a text input module (or set of instructions), a Global Positioning System (GPS) module (or set of instructions), and applications (or set of instructions).

The operating system (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The contact/motion module may detect contact with the touch screen 132 (in conjunction with the display controller 126) and other touch sensitive devices (e.g., a touchpad or physical click wheel). The contact/motion module includes various software components for performing various operations related to detection of contact, such as determining if contact has occurred, determining if there is movement of the contact and tracking the movement across the touch screen 132, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module and the display controller 126 also detects contact on a touchpad.

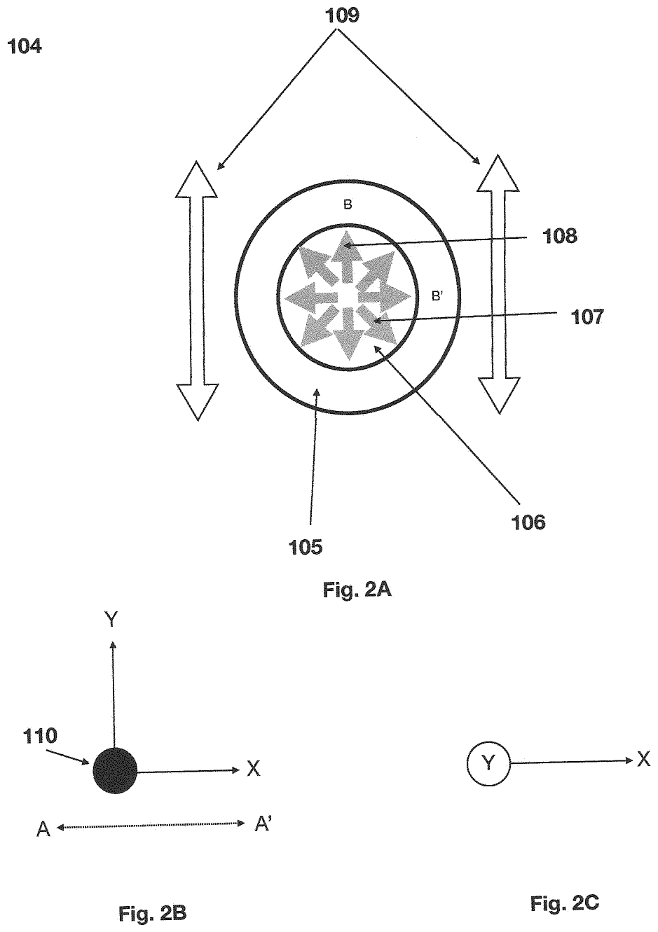

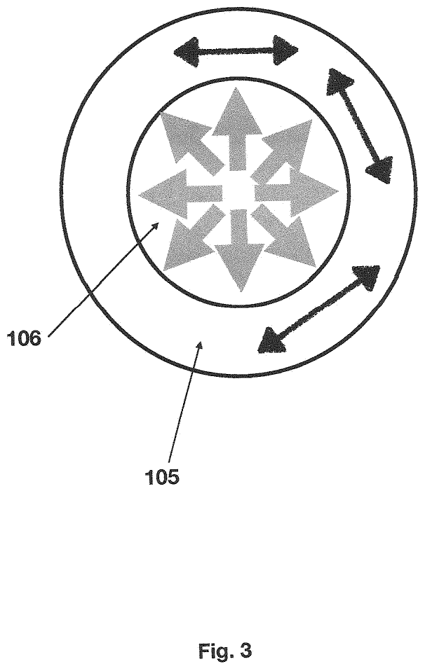

FIG. 2A illustrates one embodiment of the navigational UI 104. The UI 104 may be displayed on any digital device. UI 104 includes various sections that response to user's touch. Area 106 is a first circular navigational area that may be used to navigate in any direction depending on which parts of the area is being touched by the user. For example, if a user touches the arrow 107, as a result of such touch event, the user's position in the virtual environment will be moved toward south east direction. FIGS. 2A and 2B help demonstrate the relation of the navigational elements of UI 104 with respect to a user's field of view. Assume UI 104 is on a screen of a mobile phone being held by a user. Circle 110 in FIG. 2B represents top of a head of the user. The Y-axis represents the front of user (Y-axis is in the direction of the horizon), and X-axis represents the right side of the user. When user touches arrow 108 the view of the user in the virtual environment moves forward in the direction of the Y-Axis. FIG. 2C shows the cross section of FIG. 2B along lines A and A′. In FIG. 2C, Y is the forward direction same as FIG. 2B and X is the right hand side direction.

In FIG. 2A area 105 is a second circular navigational area that wraps around area 106 such that the area 105 and 106 form two concentric circles. Area 105 may be used for rotation. For example, assuming user's front view is in the Y direction, when the user swipes his finger in a clock-wise motion from area marked as B in area 105 toward area marked as B′, the field of view in the screen starts to rotate from the Y direction toward the X direction in a continuous manner. In one embodiment, for each one degree of swipe by user's finger along the circular area defined by area 105, the field of view also rotates by one degree such that going along the full length of the perimeter of area 105 results in a 360 degree rotation. In one embodiment, area 105 may provide various modes of rotation depending on the circumstances.

In another embodiment, if a virtual object is in front of the field of the view of the user, swiping a finger along the curved line defined by area 105 may rotate the field of view of the user around the virtual object. Therefore, functionality of the area 105 may change depending on the location of the user within the virtual environment. Arrows 109 can be used to elevate the field of view of the user, specifically, arrows 109 may allow the user to “fly” within the virtual environment.

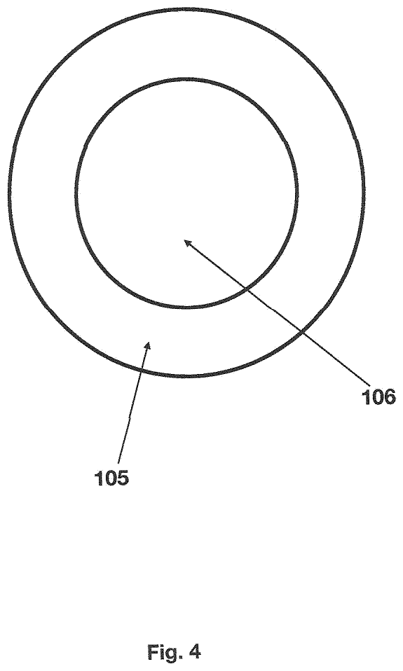

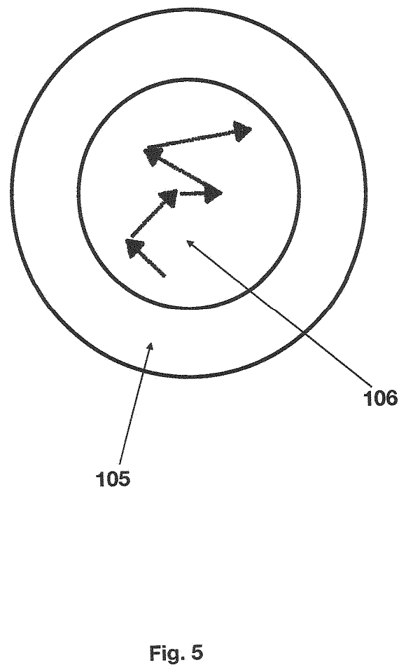

FIG. 5 shows a method of interacting with area 105. Area 105 is a wheel-like interface where users can swipe their finger along the curved path in any direction to rotate the field of view. In one embodiment, shown in FIG. 4, area 106 may not have any arrows and the user may use that area similar to a trackball to freely move their finger in any direction within the boundary of area 106 to navigate in various direction within a virtual environment. An example is shown in FIG. 5, users can swipe their finger within area 106 in any direction, and similar to a trackball, the user can roll an imaginary ball represented by the circular area 106 to control the movement within a virtual environment. In one embodiment, if the user moves his finger is various directions with the area 106, the resulting vector is calculated within a predetermined amount of time (for example, every few millisecond) and the user moves in that direction within the virtual environment.

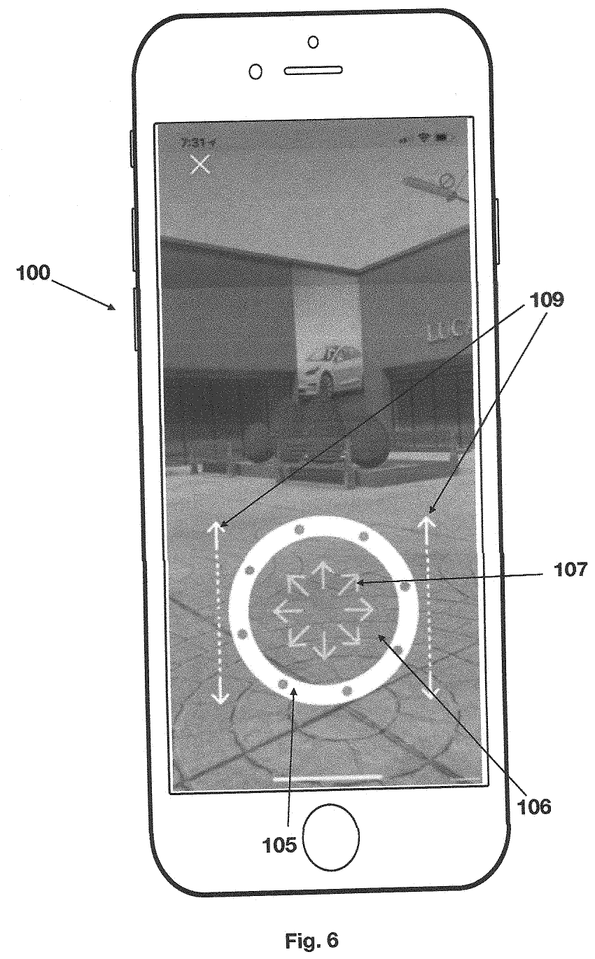

FIG. 6 shows an example of the navigational UI 104 on a mobile application being shown on a touch screen device 100. In the exemplary embodiment shown in FIG. 6, area 105 is used for rotating the field of view while the area 106 is used for navigation. Also, arrows 109 are used to modify the elevation.

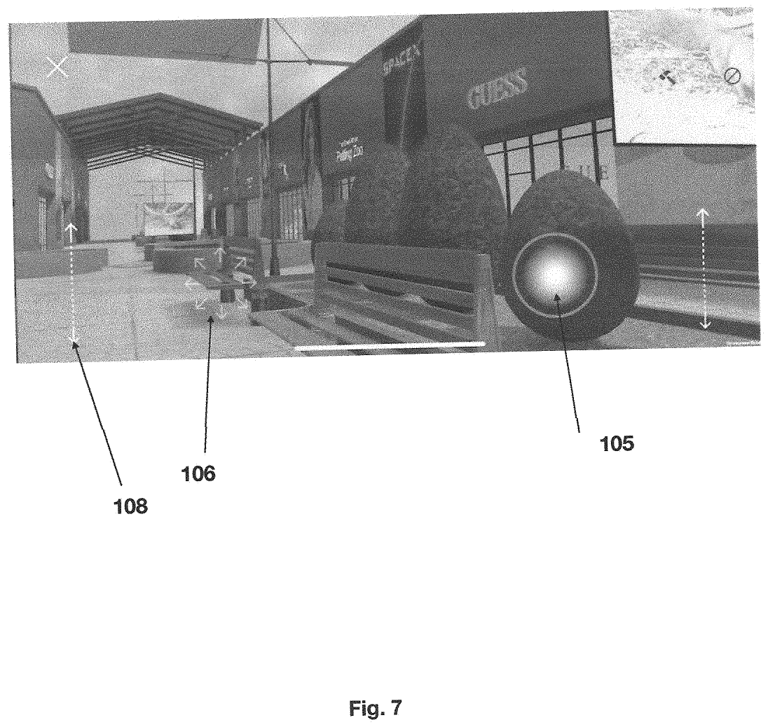

FIG. 7 shows an embodiment of the navigational UI in landscape mode. In this embodiment, areas 105 and 106 are separated. This orientation is helpful in situations where the navigational UI is shown on a handheld device and when the user rotates the device in a landscape mode, the UI changes to accommodate the user holding the device with two hands and having access to all functionalities of the UI. The portrait mode as shown in FIG. 6 superimposes areas 105 and 106 so that they can be accessed with one hand.

In one embodiment, the area 106 can be sensitive to the amount of force exerted by a user's finger on a digital display that shows the UI such that more force can speed up the movement within the virtual environment. For example, in a large environment, once a “force touch” which may mean more pressure applied to the touch screen display, is detected, then the movement of the user can be accelerated toward that direction. Some mobile devices are equipped with sensors to provide haptic feedback to user by making the device vibrate in certain manner. The haptic feedback may also be used to indicate to the user that the acceleration mode has been activated.

It is important to note that in the context of movement within a virtual environment, the screen of the portable device (for example, a mobile phone) can basically act as a window into another world, and as such, the user is free to move the device in any direction as if he is turning his head around, and while doing so, the screen shows that specific view from that specific angle. The novel design of the UI 104 allows the user to be stationary while at the same time he can tilt the device up and down and from side to side to see the virtual environment around him and use the navigational element to move about the environment. Note that the user can technically turn around to see what is behind him in the virtual environment instead of using the navigation al area 105, but in a scenario where the user is sitting, turning around would be inconvenient. In that case the user can still freely move, tilt the phone up and down, and side to side to see the virtual environment and use the navigational areas 105 and 106 to move and rotate within the environment. The ability of the user to move the phone to see various angles in concert with the novel navigational design of UI 104, allows a user to conveniently navigate through an immersive virtual environment on a portable device without having to physically move about that environment.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

What is claimed is:

1. A computing device, comprising:
a touch screen display;
one or more processors;
memory; and
one or more programs, wherein the one or more programs are stored in the memory and configured to be executed by the one or more processors, the one or more programs including:
instructions for detecting one or more finger contacts with the touch screen display;
instructions for applying a heuristic to the one or more finger contacts to determine a command for the device; and
instructions for processing the command;
wherein the heuristic comprises:
a first navigational heuristic for movement within a virtual environment along a X-Y axis, wherein a first touch event within a first circular navigational area defined by a first circular navigational element shown on the touch screen display results in movement within the virtual environment; and
a second navigational heuristic for rotation within the virtual environment along the X-Y axis direction, wherein a second touch event within a second circular navigational area defined by a second navigational element shown on the touch screen display results in rotational movement within the virtual environment.

2. The computing device of claim 1, wherein the movement along X-Y axis comprises of moving forward, moving backward, moving to the right side and moving to the left side, and wherein X is in direction of horizon.

3. The computing device of claim 1, wherein the rotation along the X-Y axis comprises of rotational movement about a coordinate in the X-Y axis.

4. The computing device of claim 1, wherein when the touch screen display is in portrait orientation, the second circular navigational area resides entirely within the boundary of the first circular navigational area such that the first circular navigational area and second circular navigational area form two concentric circles.

5. The computing device of claim 1, wherein when the touch screen display is in landscape orientation, the first circular navigational area and the second circular navigational area are shown on the bottom of the touch screen display such that one of either first circular navigational area or the second circular navigational area is on the bottom right corner of the touch screen display and the other of either first circular navigational area or the second circular navigational area is on the lower left corner of the touch screen display.

6. The computing device of claim 1, further comprising a gyroscope, wherein based on data supplied by the gyroscope the orientation of the computing device in a X-Y-Z coordinate is determined, and wherein field of view in the virtual environment is changed by moving the computing device along the X-Y-Z coordinate, and wherein while the field of view is changed by physical movement of the computing device, the first circular navigational area and the second circular navigational area allow navigation along the X-Y axis while physical movement of the computing device allows changing the field of view in any direction along the X-Y-Z axis.

7. The computing device of claim 3, wherein the second touch event comprises of dragging a finger in a circular fashion along the perimeter of the second circular navigation area in a clock-wise or counter-clock-wise direction, and wherein dragging a finger in a circular fashion by one degree results in rotational movement in the virtual environment by one degree, and wherein dragging the finger in a circular fashion by 360 degrees results in rotational movement in the virtual environment by 360 degrees.

8. The computing device of claim 1, wherein the first touch event comprises of dragging a finger within inside the first circular navigational area.

9. A computing device, comprising:
a touch screen display;
one or more processors;
memory; and
one or more programs, wherein the one or more programs are stored in the memory and configured to be executed by the one or more processors, the one or more programs are configured to:
display on a first location of the touch screen display a first circular navigational element, wherein the first circular navigational element includes a first circular area within which a first touch event results in movement in a virtual environment, and
display on a second location of the touch screen display a second circular navigational element, wherein the second circular navigational element includes a second circular area within which a second touch event results in results in rotational movement within the virtual environment.

10. The computing device of claim 9, wherein the one or more programs are further configured to display on a third location of the touch screen display a third navigational element, wherein the third navigational element includes at least one straight line, wherein a touch along the length of the straight line alters the elevation of the field of view.

11. The computing device of claim 9, wherein the touch screen display further comprises one or more sensors adapted to capture an amount of force applied to the touch screen display resulting from the first touch event, and wherein the movement in the virtual environment is along a X-Y axis, wherein X is in the direction of horizon, and wherein the movement comprises of moving forward, moving backward, moving to the right side and moving to the left side, and wherein when the amount of force of the first touch event is beyond a pre-determined threshold, the movement is accelerated.

12. The computing device of claim 9, wherein the first touch event in the first circular navigational area is in the form of dragging a finger in any direction, and wherein the direction of the movement is the resulting vector from adding all linear movements of the finger within the first circular navigational area.

13. The computing device of claim 9, further comprising a gyroscope, wherein based on data supplied by the gyroscope the orientation of the computing device in a X-Y-Z coordinate is determined, and wherein field of view in the virtual environment is changed by moving the computing device along the X-Y-Z coordinate, and wherein while the field of view is changed by physical movement of the computing device, the first circular navigational area and the second circular navigational area allow navigation along the X-Y axis, the X axis being in the direction of the horizon, while physical movement of the computing device allows changing the field of view in any direction along the X-Y-Z axis.

14. The computing device of claim 13, wherein the physical movement of the computing device includes changes in roll, pitch and yaw of the computing device with respect to the X-Y-Z coordinate.

15. A computer-executable method for navigating within a virtual environment shown on a digital touch screen device, comprising:
displaying on a first location of a digital screen a first circular navigational element, wherein the first circular navigational element includes a first circular area within which a user's touch results in movement in the virtual environment, wherein when a touch screen device within a portable computing device receives a first touch event within the first circular navigational area a movement results within the virtual environment, and
displaying on a second location of the digital screen a second circular navigational element, wherein the second circular navigational element includes a second circular navigational area within which the users touch results in rotation of a field of view in the virtual environment, wherein when the touch screen device receives a second touch event within the second circular navigational area rotational movement results within the virtual environment.

16. The method of claim 15, further comprising:
displaying on a third location of the digital screen a third navigational element, wherein the third navigational element includes at least one straight line, wherein user's touch along the length of the straight line alters the elevation of the field of view.

17. The method of claim 15, wherein the second touch event comprises of dragging a finger in a circular fashion along the perimeter of the second circular navigation area in a clock-wise or counter-clock-wise direction, and wherein dragging a finger in a circular fashion by one degree results in rotational movement in the virtual environment by one degree, and wherein dragging the finger in a circular fashion by 360 degrees results in rotational movement in the virtual environment by 360 degrees.

18. The method of claim 15, wherein the first touch event comprises of dragging a finger within inside the first circular navigational area.

19. The method of claim 15, wherein the second navigational element visually encapsulates the first navigational element such that the first circular area is located within the second circular area.

20. The method of claim 1, wherein the movement within the virtual environment facilitated by the first navigational elements includes movement in forward direction, backward direction, right side direction, left side direction, upper right direction, upper left direction, lower right direction and lower left direction within the virtual environment.
